(19) United States
(12) Patent Application Publication
(10) Pub. No.: US 2022/0363015 A1
(43) Pub. Date: Nov. 17, 2022

(54) EMBEDDED POLYMERIC INSERT FOR INCREASED TOUGHNESS OF ADHESIVE BONDED JOINT

(71) Applicants: KING ABDULLAH UNIVERSITY OF SCIENCE AND TECHNOLOGY, Thuwal (SA); UNIVERSITÁ DELLA CALABRIA, Arcavacata di Rende (IT)

(72) Inventors: Arief YUDHANTO, Thuwal (SA); Gilles LUBINEAU, Thuwal (SA); Marco ALFANO, Calabria, Rende (IT); Ran TAO, Thuwal (SA)

(21) Appl. No.: 17/627,190

(22) PCT Filed: Jul. 22, 2020
(86) PCT No.: PCT/IB2020/056917

§ 371 Date: Jan. 14, 2022

Related U.S. Application Data
(60) Provisional application No. 62/957,901, filed on Jan. 7, 2020.
(60) Provisional application No. 62/880,248, filed on Jul. 30, 2019.

(51) Int. Cl. B29C 65/48

(52) U.S. Cl. CPC B29C 65/48; B29K 2105/04

(57) ABSTRACT

A bonded composite joint includes a first carbon fiber-reinforced polymer (CFRP) panel; a second CFRP panel; a corrugated structure placed between the first and second CFRP panels; and an adhesive placed between the first and second CFRP panels and in contact with the corrugated structure. The corrugated structure has a shape defined by a given wavelength λ.

### CROSS-REFERENCE TO RELATED APPLICATIONS

This application claims priority to U.S. Provisional Patent Application No. 62/880,248, filed on Jul. 30, 2019, entitled “METHOD FOR INCREASING THE TOUGHNESS OF ADHESIVE BONDED COMPOSITE JOINTS USING AN EMBEDDED POLYMERIC MESH/NET,” and U.S. Provisional Patent Application No. 62/957,901, filed on Jan. 7, 2020, entitled “METHOD FOR INCREASING THE TOUGHNESS OF ADHESIVE BONDED COMPOSITE JOINT USING AN EMBEDDED POLYMERIC INSERT,” the disclosures of which are incorporated herein by reference in their entirety.

### BACKGROUND

### TECHNICAL FIELD

Embodiments of the subject matter disclosed herein generally relate to a method and system for adhesive bonding two composite panels, and more particularly, to adding crack-arrest features between the two composite panels that form a joint for increasing a toughness of the bonding between the panels.

### DISCUSSION OF THE BACKGROUND

Carbon fiber reinforced polymer (CFRP) composite panels have been increasingly used to fabricate aircraft parts requiring a high specific strength (or stiffness). The parts made of CFRP composites are typically bonded together by co-curing, co-bonding or secondary bonding. In the secondary bonded parts, the joining technique of two or more composite panels (that have been independently cured) is carried out using bolt/rivet (mechanical fastening), adhesive (bonding) or a combination of both. However, bolting/riveting usually introduces geometrical perturbations (holes) in the CFRP composite panels, which is conducive to a high stress concentration and possible bearing failure due to micro-buckling and delamination. In contrast, adhesive bonding preserves a more uniform stress along the bonded area. Adhesive bonding also reduces the cost of the joint by eliminating the costly machining steps needed for bolting/riveting, and is a promising approach for bonded repair.

However, the failure of the secondary bonded CFRP composite panels, which is characterized by delamination at the adherend-adhesive interface and adhesive failure, make this approach less reliable. In this regard, the performance and the failure of the secondary bonding are highly dependent upon surface treatment, adhesive types (rubbery or rigid), joint design, and environmental conditions. Therefore, a method to enhance the delamination resistance of the secondary bonded CFRP composite panels as well as to promote an increasing R-curve response is desirable. A more ductile response can be guaranteed by using crack stopping features implemented at the latest stage of integration.

Methods for improving the delamination resistance include stitching, z-pinning, and interleaving. However, these methods induce architectural and mechanical shortcomings, such as fiber waviness, in-plane stiffness reduction (stitching or z-pinning), and manufacturing complexity. In addition, these methods are mostly applicable for co-cured CFRP composite panels rather than for the secondary bonding.

Dedicated methods for improving the delamination resistance for the secondary bonded CFRP composite panels, the so-called crack stopping features, include thermoplastic crack stopper, corrugation, staples, surface interfering features, X-type arresters, formation of adhesive ligaments, or adhesive bondline architecturing. Nevertheless, most of these methods also incur manufacturing complexity, except for the adhesive bondline architecturing. The adhesive bondline architecturing, which consists of introducing a specific heterogeneous morphology either at the adhesive-substrate interfaces or within the adhesive layer, could be a promising method since it can be easily implemented, provides sufficient bridging traction for improving delamination resistance, is tailorable, and is also applicable for bonded repairs (latest stage of implementation).

In fact, promising results have been obtained recently by introducing patterns at the mating surfaces of a joint so as to improve the adhesion properties of the adhesive-substrate interface, as discussed in [1]. This reference uses an adhesive layer that is actually a bulk thermoset layer; however, controlling its adhesion with the substrates triggers new mechanisms of dissipation, such as long-range bridging, that promotes an increasing of the R-curve response. Instead of patterning the substrates in order to modify the adhesion properties between the adhesive layer and the substrates, another option is to directly pattern the adhesive layer, for example, by inserting crack arrest features inside the adhesive layer. Although the copper mesh proposed in [2] effectively improved the fracture toughness, it was unfortunately non-stretchable (less ductile) and relatively heavy. A nylon mesh described in [3] is indeed stretchable, but is designed for controlling the bondline thickness rather than for enhancing the fracture toughness of the CFRP composite joint. As such, its deployment following fracture of the bondline is not necessarily guaranteed.

Therefore, there is still a need to find a design of an adhesive layer (bondline architecture) that is easy to implement, tailorable (freedom in design), and effective for fracture toughness enhancement for CFRP joint via extrinsic toughening.

### BRIEF SUMMARY OF THE INVENTION

According to an embodiment, there is a bonded composite joint that includes a first carbon fiber-reinforced polymer (CFRP) panel, a second CFRP panel, a corrugated structure placed between the first and second CFRP panels, and an adhesive placed between the first and second CFRP panels and in contact with the corrugated structure. The corrugated structure has a shape defined by a given wavelength λ.

According to another embodiment, there is a corrugated structure configured to be placed between first and second composite panels for forming a joint. The corrugated structure includes a mesh carrier made of nylon, and a weft net made of nylon, where the weft net shapes the mesh carrier to achieve a shape having a given wavelength λ.

According to yet another embodiment, there is a method for forming a bonded composite joint, and the method includes providing a first carbon fiber-reinforced polymer (CFRP) panel, providing a second CFRP panel, adding an adhesive to at least one of the first and second CFRP panels, placing a corrugated structure between the first and second CFRP panels, and pressing the first and second CFRP panels to form pores, which are defined by the first and second CFRP panels, the corrugated structure, and the adhesive. The corrugated structure has a shape defined by a given wavelength λ.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a bonded composite joint made with a corrugated structure between first and second composite panels;

FIG. 2 shows a cross-section of the bonded composite joint made with the corrugated structure;

FIG. 3 illustrates physical characteristics of the various components of the bonded composite joint;

FIG. 4 illustrates one of the composite panels being laser treated to expose its carbon fibers prior to bonding;

FIG. 5 illustrates the characteristics of the laser used to expose the carbon fibers of the composite panels;

FIGS. 6A and 6B illustrate the corrugated structure and its dimensions;

FIGS. 7A and 7B illustrate various thermal properties and characteristics of the material used for the corrugated structure;

FIGS. 8A and 8B illustrate a setup used to determine the load characteristics of the corrugated structure;

FIGS. 9A to 9C illustrate a specimen made to have the corrugated structure and how the specimen is tested for determining a toughness of the bonded composite joint;

FIG. 10 illustrates the characteristics of the various specimens tested for bond toughness;

FIGS. 11A and 11B illustrate the fracture toughness for a saturated and un-saturated bonded composite joint having different waviness;

FIG. 12 illustrates the parameters used for performing X-ray micro CT on the various specimens;

FIGS. 13A to 13D illustrate a method for determining the porosity of the adhesive used in the bonded composite joint;

FIGS. 14 to 15D illustrate various porosities for different bonded composite joints;

FIGS. 16A to 16D illustrate the strands formed between the panels of the bonded composite joints for various porosities of the adhesive;

FIGS. 17A and 17B show the strands and anchors that appear between the panels of the bonded composite joint due to the high porosity in the adhesive; and

FIG. 18 is a flow chart of a method for joining two composite panels with a corrugated structure.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a wavy net-like thermoplastic insert (corrugated structure) that is embedded within the thermoset adhesive bondline to introduce new mechanisms of energy dissipation. However, the embodiments to be discussed next are not limited to such a design.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a crack-stopping feature is introduced between the CFRP composite panels that are joined together, and the crack-stopping feature includes a specifically designed wavy net made, for example, of 3D-printed nylon, and this feature is embedded in the adhesive bondline of the CFRP composite joint. By adopting the 3D printing technology, the method achieves design freedom and quick implementation. A similar technology has been implemented in improving CFRP's performance by implementing crack arrest features in a single-lap joint [4, 5] and end-notch flexure configurations [6].

In one embodiment, two parameters of the crack-arresting feature are controlled, namely (1) the wavelength of the net waviness, and (2) the volume of adhesive (related to the porosity). These two parameters are shown herein to influence the fracture toughness and corresponding failure mechanism. For selected values for these parameters, the inventors were able to show that this feature was not only able to greatly enhance the Mode I fracture toughness of the secondary bonded CFRP composite panels, but also to introduce a significant increase of the R-curve, which is very promising for the design of efficient crack-arrest features. This feature and its two parameters are now discussed in more detail.

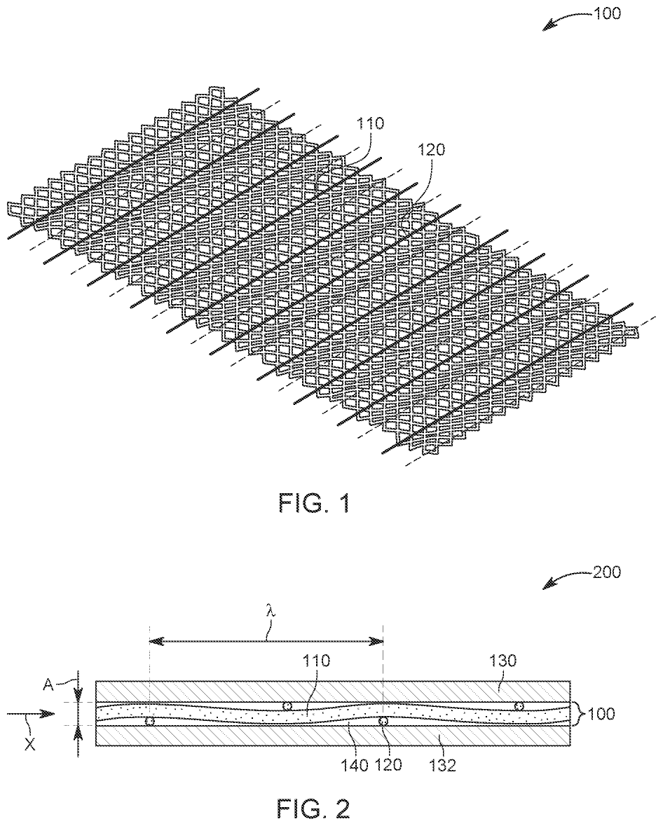

As illustrated in FIG. 1, a corrugated structure 100 or thermoset insert, which includes a mesh carrier 110 and a weft net 120, is integrated into (or “sandwiched” between) laminated composite panels 130 and 132, as shown in FIG. 2, to form a bonded composite joint 200. A certain amount of epoxy adhesive 140 (liquid or solid) is applied to the corrugated structure 100 so that a desired porosity of the epoxy adhesive is achieved when the panels 130 and 132 squeeze the corrugated structure 100 and the adhesive 140. In one application, the adhesive 140 is deposited directly on the panels. In another application, the adhesive 140 is attached first to the corrugated structure 100 and then to the panels 130 and 132. The porosity of the epoxy adhesive is discussed later. The corrugated structure 100 is configured to achieve the corrugated (wavy) configuration, as shown in FIG. 2, and the corrugated configuration has a given wavelength λ by inserting the weft carrier 120.

The purpose of such a corrugated structure is to introduce a geometrical asymmetry between the two composite panels 130 and 132, so that a ligament can be triggered during the crack propagation. The corrugated structure is obtained in this embodiment by interweaving the plane mesh 110 with the weft net 120. In one application, the plane mesh 110 is flat when manufactured and the addition of the weft net 120 makes the plane mesh 110 wavy, as shown in FIG. 2. Those skilled in the art would understand that the same wavy (corrugated) structure 100 can be obtained in various ways, for example, molding, 3D printing, injection, laser cutting, etc.

For testing the bonding between the composite panels 130 and 132 when using the corrugated structure 100, the following materials have been used. Carbon/epoxy (T700/M21 Hexply, Hexcel) was used for manufacturing the adherends (composite panels) 130 and 132. T700/M21 prepregs with [0]₈ lay-up were manually stacked, cured under vacuum (1 bar) and then compressed using a static press under 7 bar pressure and 180° C. for 2 h. The heating and cooling rates during processing were set at 3° C./min. The dimension of the resulting plate was 300 mm×300 mm, while the thickness was 2 mm. The plate was cut into two 250 mm×88 mm composite panels 130 and 132 for the subsequent surface treatment. The adhesive paste used for bonding the carbon/epoxy adherends 130 and 132 was a two-component epoxy (e.g., Araldite 420 A/B, Huntsman) with a weight mixing ratio of 10:4 between the resin and the hardener, respectively. Other adherents may be used.

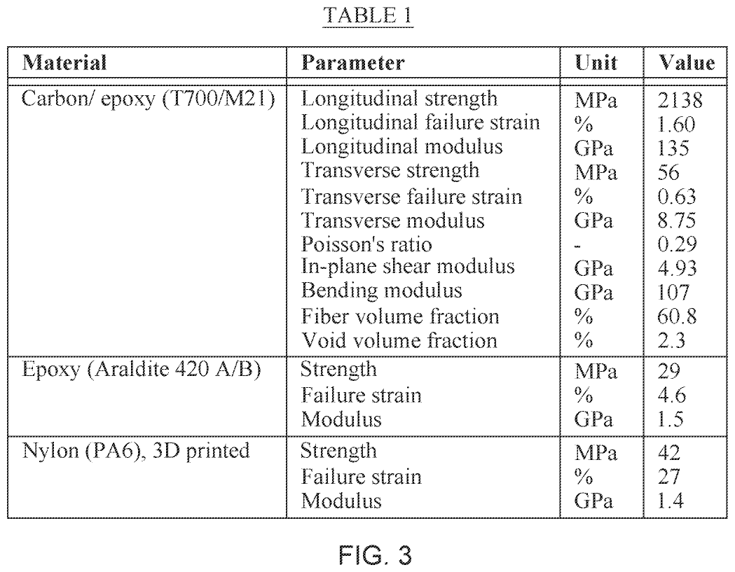

The thermoplastic insert 100 was made of nylon (polyamide 6 or PA6), and it was manufactured using a 3D printer. This means that in one application, both the mesh carrier 110 and the weft net 120 are made of nylon. In still another application, the mesh carrier 110 and the weft net 120 are integrally made as a single structure, for example, by 3D printing. Other manufacturing methods may be used. Basic mechanical properties of the T700/M21 prepregs, the two-component epoxy, and the nylon (PA6, 3D printed part) are shown in Table 1 in FIG. 3. It should be noted that the PA6 is much more ductile than Araldite 420, making it a good candidate for the insert.

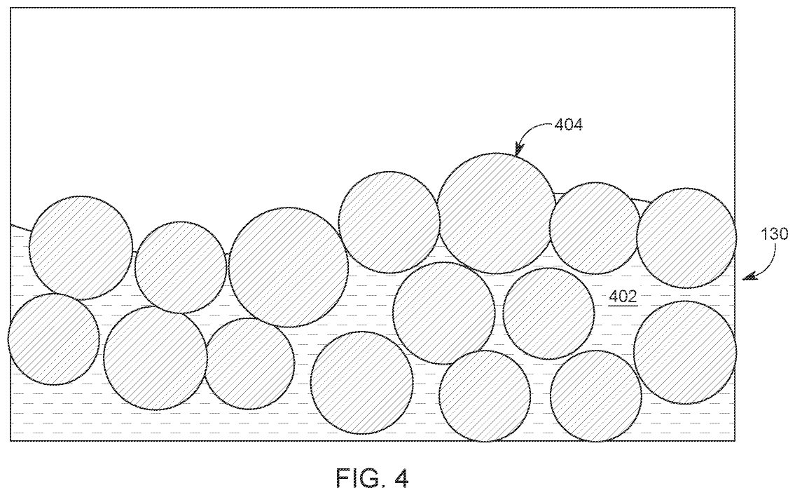

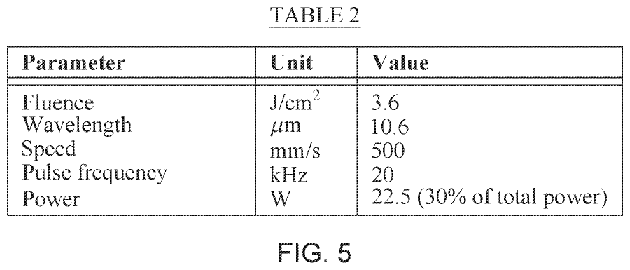

The surface of the carbon/epoxy adherends 130 and 132 was uniformly treated using pulsed CO₂ laser irradiation to remove a thin part of the epoxy layer 402 on the surface, to expose the top fibers 404 that make up the composite panels. The laser treatment is a reproducible and scalable technique that could modify the mechanical performance of the composites, e.g., bonding strength, joint strength, fracture toughness, etc. The parameters applied during this treatment are shown in Table 2, in FIG. 5, and are similar to the ones used in previous studies of the inventors. The laser ablation enabled the carbon fibers 404 to be exposed (see FIG. 4) so they could make a direct contact with the adhesive 140. After this laser treatment, the carbon/epoxy plate was further cleaned using acetone, within an ultrasonic cleaner for 30 mins, and then the plate was dried at 60° C. for 30 mins.

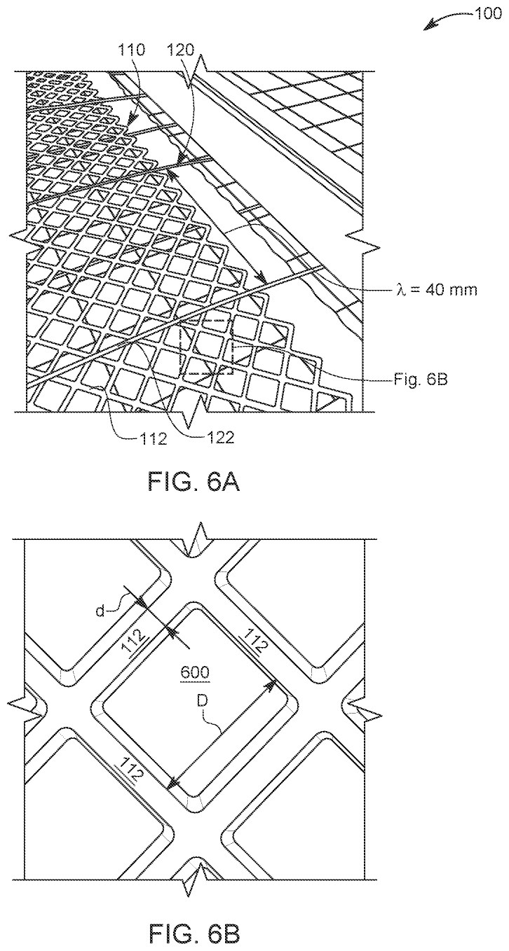

The corrugated structure 100 was manufactured in this embodiment using a 3D printer. The 3D printer was configured to print the flat mesh carrier 110 so that the cords 112 making up the flat mesh carrier 110 have a 0.5 mm diameter, and the cords 122 making up the weft net 120 have a 0.3 mm diameter, as shown in FIG. 6A. The cords 112 are also shown in FIG. 6B having a diameter d of 0.5 mm and a distance D between two adjacent cords can be around 4 mm. To create the desired waviness of the structure to breaks its symmetry, the flat mesh carrier 110 was weaved into the weft net 120, creating the corrugated structure 100 with a total thickness of 0.8 mm, which represents the bondline thickness A, which is shown in FIG. 2.

The corrugated structure (or wavy insert) 100 was designed to have the following characteristics: (i) to be non-symmetrical with respect to a neutral axis X of the bondline (see FIG. 2) in order to anchor at best on both interfaces and to enable the creation of bridging strands, (ii) to be sufficiently thin to be integrated within the bondline between the two composite panels, and (iii) to be practically viable to be manufactured using various techniques.

Two types of inserts were tested with different wavelengths λ, i.e., a short wavelength (λ=20 mm), and a long wavelength (λ=40 mm). The wavelength λ can take any value between 20 and 40 mm. In one application, the wavelength is selected to be less than 100 mm. FIG. 6A shows the λ=40 mm wavelength. Those skilled in the art would understand that other wavelengths may be used. The spacing between two cords 122 of the weft net 120 is 10 and 20 mm in order to make the short and long wavelengths, respectively. Because the cords 122 are straight, parallel, lines in this embodiment, the flat net 100 is made to extend above one cord 122, and then below the adjacent cord 122, and then again above another adjacent cord 122, as shown in FIGS. 2 and 6A. This wavy configuration can be implemented, in one application, to follow a sinusoidal, with a given amplitude, for example, A/2, and the phase of the sinusoidal being related to the wavelength λ (e.g., phase=2πλ). Thus, if a cross-section is made through the mesh carrier 110, as shown in FIG. 1, the cross-section follows the sinusoid.

While the distance between adjacent cords 122 of the weft net 120 can be changed, as discussed above, the sizes of a unit cell 600 of the mesh carrier 110, as shown in FIG. 6B, can also be adjusted as desired. The 3D printing parameters (d, D) can be optimized to produce the corrugated structure 100 with a uniform thickness. The extruder's temperature of the 3D printer for this embodiment was set at 245° C. so that a 0.4 mm diameter nozzle could inject a molten nylon on the heated bed having a temperature of 75° C. The printing speed was 60 mm/s with a layer height of 0.1 mm, while the infill was set to zero. Other numbers may be used for the corrugated structure 100.

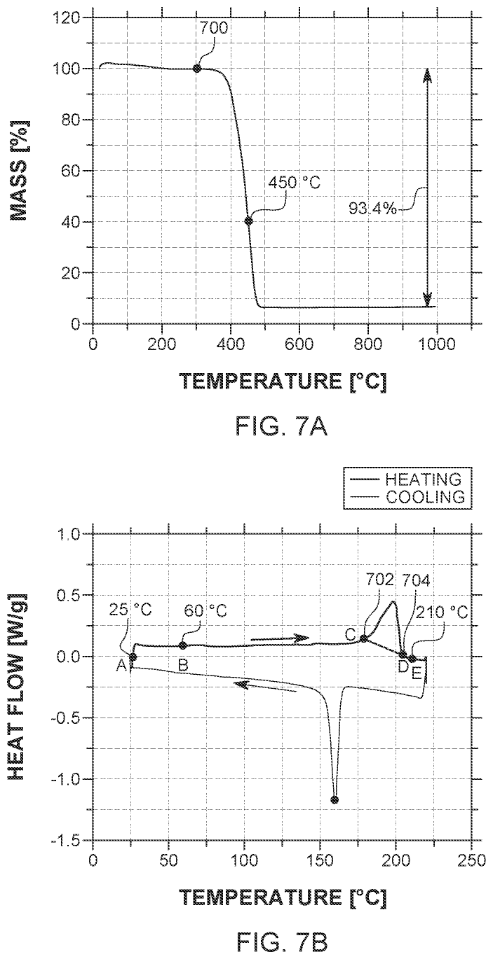

The obtained corrugated structure 100 is now characterized in terms of temperature, adhesion, breaking mechanism, and X-ray micro-computed tomography. For the temperature characterization, thermogravimetric analysis (TGA) was used to identify the initial decomposition temperature and total mass change of the nylon (PA6). For this test, 15 mg of pristine PA6 were inserted into a metallic crucible, and then heated from 25 to 1000° C. at 10° C./min, and cooled down to 25° C. at 10° C./min with the aid of liquid nitrogen. Differential scanning calorimetry (DSC) performed during the heating and cooling reveal the onset and endset of the melting temperatures of PA6, which are plotted in FIGS. 7A and 7B. Then, 3.5 mg of pristine PA6 were inserted into a metallic crucible, and the sample was heated from 25 to 220° C. at 10° C./min in order to remove the thermal history (first cycle), and subsequently the temperature was reduced to 25° C. at 10° C./min (second cycle).

A heating stage was used to capture in situ the melting process of the PA6. A small filament (0.8 mm diameter) with 5 g weight was subjected to the temperatures of 25, 60, 180, 200 and 210° C. (heating rate =100° C./min; dwell time =1 min), while the morphological changes were observed using a 10× optical microscope. In addition, larger samples with the dimension of 3×1 mm were also subjected to the temperatures of 25, 60, 180, 200 and 210° C. in an oven for 15 min with the aim of observing any discoloration that might occur in nylon.

The TGA results are displayed in FIG. 7A and they show that the nylon experienced mass degradation (decomposition) at point 700, of about 300° C., below which it is thermally stable. The DSC thermogram depicted in FIG. 7B shows that the nylon started to melt at 183° C. (melting onset temperature 702) and completely melted at 202° C. (melting endset temperature 704). The in situ observation using a heating/cooling stage shows that the nylon started to melt at 200° C. and completely melted at 210° C. However, the nylon started to exhibit a discoloration at 180° C., i.e., it transformed from the originally white into yellowish color. Discolored nylon would exhibit lower failure strain (more brittle) than the pristine one. Thus, the safe temperature for the nylon when used into the bondline of the bonded joint is below 180° C. Therefore, the inventors selected the processing temperature of the corrugated structure 100 to be around 60° C., as a safe condition with some safety margins. It is however understood that if other materials are used for the insert, the above temperature could be also increased.

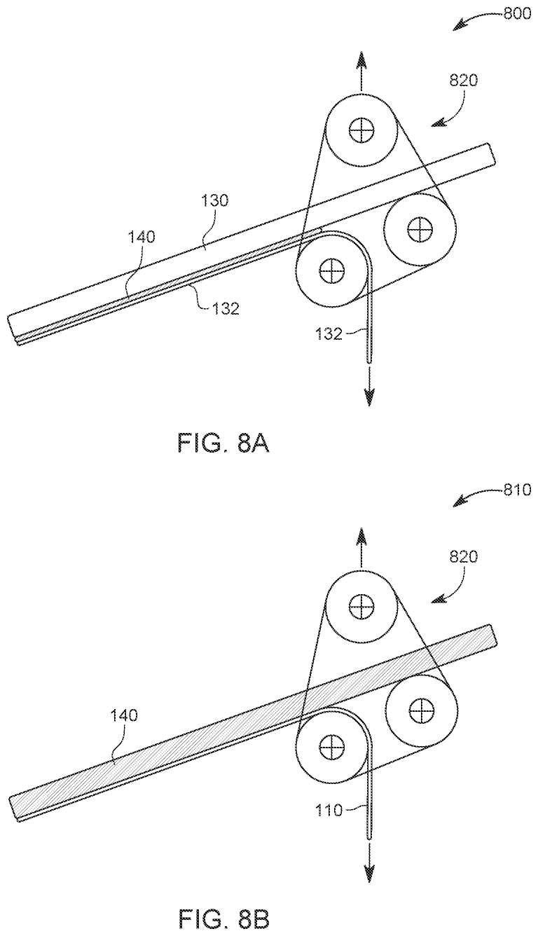

Next, to understand the adhesion properties of the corrugated structure 100, a floating roller test (FRT) was performed. ASTM D3167 standard was adopted to measure the peel strength between the flexible and rigid adherends of two configurations: (i) CFRP-epoxy-CFRP 800 (used as a reference and illustrated in FIG. 8A), and (ii) epoxy-nylon 810 (illustrated in FIG. 8B), to explore the adherence between the epoxy and the nylon. Note that the CFRP composite panel 130 was selected to be rigid while the CFRP composite panel 132 was selected to be flexible in FIG. 8A and the epoxy 140 and the nylon 110 were selected to be flexible in FIG. 8B.

In the CFRP-epoxy-CFRP configuration 800, the stacking sequence of the flexible and rigid CFRP adherends were [0] and [0/90/0/90/0]s, respectively. The flexible CRFP adherend 132 had dimensions of 250 mm length, 25 mm width, 0.34 mm thickness, while the rigid CFRP adherend 130 had dimensions of 140 mm length, 25 mm width, and 2.54 mm thickness. The epoxy bondline was Araldite 420 A/B with a thickness of 329 μm.

In the epoxy-nylon configuration 810, the epoxy 140 and the 3D-printed nylon mesh 110 were used as rigid and flexible adherends, respectively. The dimension of the epoxy was 185 mm length, 12.5 mm width and 3 mm thickness with an initial 50 mm crack, while the dimensions of the nylon were 250 mm length, 12.5 mm width and 0.5 mm thickness. The nylon strip 110 was directly bonded to the epoxy 140, when still in its liquid state, and both were immediately cured at 60° C. for 195 mins. As the nylon strip 110 was obtained by 3D printing, with one face resting on the glass bed of the 3D printer, the interface of the nylon strip can be rough or glossy: the interface directly attached to the glass bed was glossy, while the opposite side was rough.

Three samples were prepared for each configuration to get a clear information about how much the surface finishing was influencing the adhesion properties. The FRT test was performed using a 2 kN load cell 820 at the loading speed of 152 mm/min. The load-displacement curves obtained from the FRT tests for the CFRP-epoxy-CFRP configuration 800 indicate that the average peel strength, calculated from plural specimens, between 50 and 150 mm, has a displacement of 0.51±0.05 N/mm, which is slightly higher than those reported in the art (peel strength was 0.28-0.36 N/mm for various epoxy types). The load-displacement curves from the FRT tests of the epoxy-nylon bonding configuration shown in FIG. 8B indicate that the bonding between the nylon and epoxy was strong as indicated by the higher peel strength in comparison to the CFRP-epoxy-CFRP bonding configuration 800, i.e., 1.51±0.74 N/mm (for glossy interface attached to the epoxy) and 1.99±0.75 N/mm (for rough interface attached to the epoxy). The strong interlocking between the nylon and epoxy as measured by the FRT is a result of the mechanical keying between the epoxy and nylon, as well as the chemical bonding between the amide (N—H) groups of the nylon and the epoxide groups of the epoxy. It should be mentioned that the tests performed by the inventors evaluated the adhesion between the nylon that is directly printed on the CFRP composite panel, but the adhesion between the nylon and the CFRP composite panels was extremely low. Therefore, in order to ensure a strong adhesion between the epoxy and the nylon, the epoxy was cured while it was in contact with the nylon film.

Therefore, the inventors have observed that direct printing of nylon on the cured CFRP composite panels results in no or very poor adhesion, and the direct curing of the epoxy on the already solid thermoplastic insert results in a strong epoxy/thermoplastic interface that outperforms the original interface obtained by curing the epoxy on the cured CFRP composite panels. As a consequence, the best way to introduce the corrugated structure 100 (i.e., the thermoplastic insert) between two CFRP adherends is to introduce a layer of epoxy between the insert and the adherend that will be cured in situ.

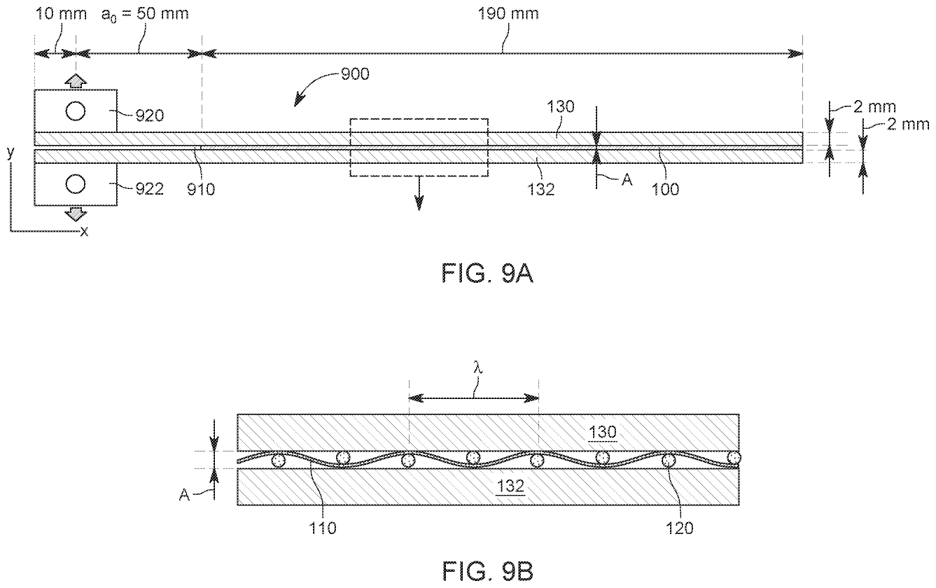

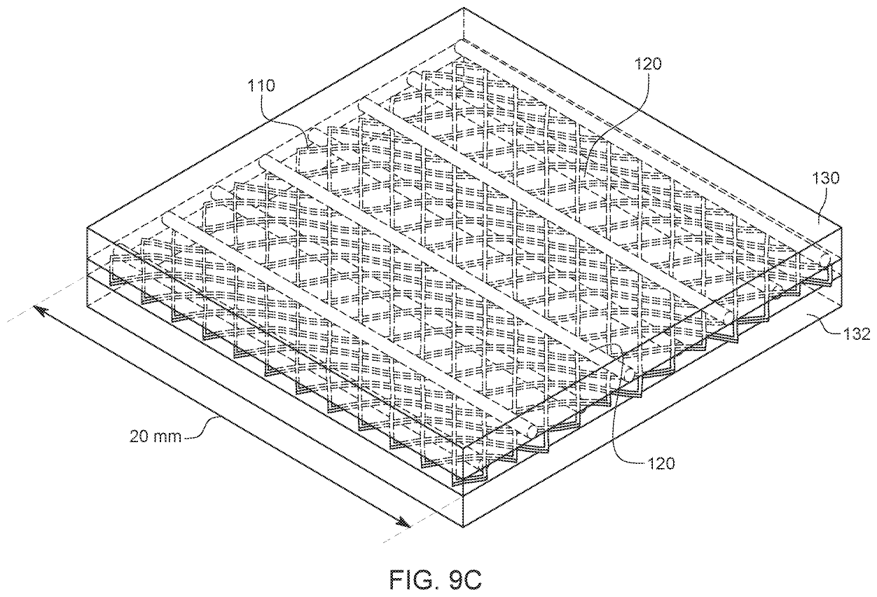

The corrugated structure 100 was also tested for determining the resistance to tear. A double cantilever beam (DCB) test method has been employed for this determination. FIGS. 9A to 9C show the schematic of the DCB specimen 900 based on ASTM D5528. The DCB specimen 900 (which has the same structure as the bonded composite joint 200) has a 250 mm length and 20 mm width. Two CFRP adherends 130 and 132 (2 mm thickness each) were bonded using the epoxy adhesive 140 (Araldite 420 A/B). The adhesive bondline thickness A was 0.8 mm, and thus the total thickness of the DCB specimen 900 is 4.8 mm. In order to integrate the corrugated structure 100, the adhesive was first applied on the 250 mm ×88 mm treated CFRP adherend 130. Since the amount of adhesive might affect the porosity level and strand formation, various samples were prepared, one with 14 g (non-saturated amount) and another one with 30 g (saturated amount) adhesive weight. The corrugated structure 100 was then laid on the CFRP adherend 130 having the thin adhesive layer. Two types of the corrugated structure 100 were used: one with the short wavelength (λ=20 mm) and another one with the long wavelength (λ=40 mm).

A non-sticky polyethylene film (80 μm thickness) 910 was then inserted between the CFRP adherends 130 and 132 to create a starter crack of 60 mm, providing an initial crack length a0 of 50 mm (measured from the loading pin 920). Subsequently, the second CFRP adherend 132 was laid over the film 910 and the corrugated insert 100, while the second CFRP adherend 132 also had a thin adhesive layer. The formed sample 900 was the placed under a 10 kg weight. Curing was performed at 60° C. during 195 mins (15 mins under vacuum, 180 mins at ambient condition). Once the adhesive bondline (insert 100 and adhesive 140) was cured, the plate was cut into individual DCB specimens. Two loading blocks (aluminum) 920 and 922 were attached to the upper and lower parts of the specimen to enable the connection with a load cell (not shown) having a 500 N capacity.

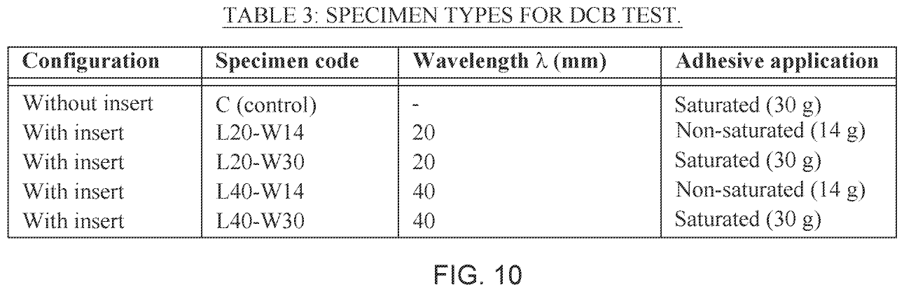

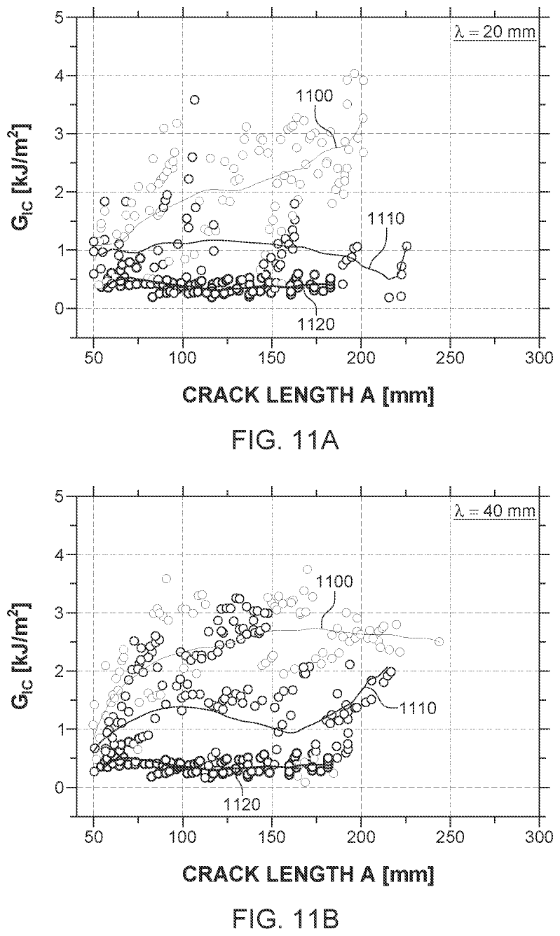

The DCB test was performed continuously with a loading speed of 2 mm/min, while the crack length (a) was recorded using a digital camera. Load (P) and displacement (δ) data was recorded by the Bluehill software. The Mode I fracture toughness G_{I}_{_{c}}, was calculated using the compliance calibration (CC) method, based on the equation:

$${G}_{{I}_{c}} = \frac{n P δ}{2 B a} ,$$

where B is the specimen width, a is the crack length, and n is the exponent of the slope between log(67 ᵢ/Pᵢ) and log(aᵢ). At least three samples were tested to obtain the G_{I}_{_{c}}, vs. the crack length (i.e., the R-curve). The specimen configurations are summarized in Table 3 in FIG. 10. The G_{I}_{_{c}} was plotted against the crack length a for the specimens with λ=20 and 40 mm as shown in FIGS. 11A and 11B, respectively. The corrugated structure 100 notably enhances the fracture toughness (initiation and propagation) by more than 100% for the specimens illustrated in FIGS. 9A to 9C. Reducing the amount of adhesive (see curve 1100 for the non-saturated adhesive and curve 1110 for the saturated adhesive) improves the fracture toughness by more than 400% with either λ=20 mm (short wave-length) and 40 mm (long wavelength), when compared to a control structure 1120. In addition, it was found that the wavelength does not significantly affect the toughness enhancement. The unexpected large increase of the fracture toughness stems from the fact that the insert 100 provides extrinsic toughening to the CFRP bonded joint 200, as discussed later.

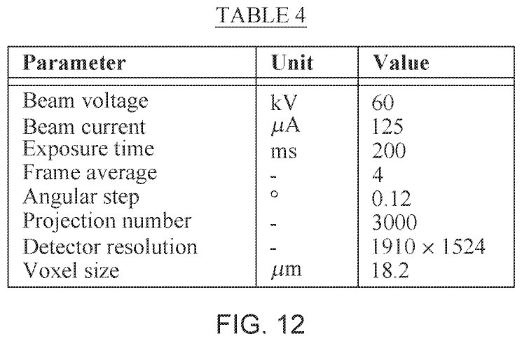

Next, the X-ray micro-computed tomography was used to quantify the porosity of the adhesive bondline in the DCB specimens 900 with and without the corrugated structure 100. The parameters used for performing the X-ray micro CT are listed in Table 4 in FIG. 12. First, the specimen was scanned and then the projection images were reconstructed using the CT Pro 3D (Nikon) software to build a volumetric image of the specimens. Visualization of the 3D image and sliced surfaces were obtained using the Avizo software (Thermo Fisher Scientific).

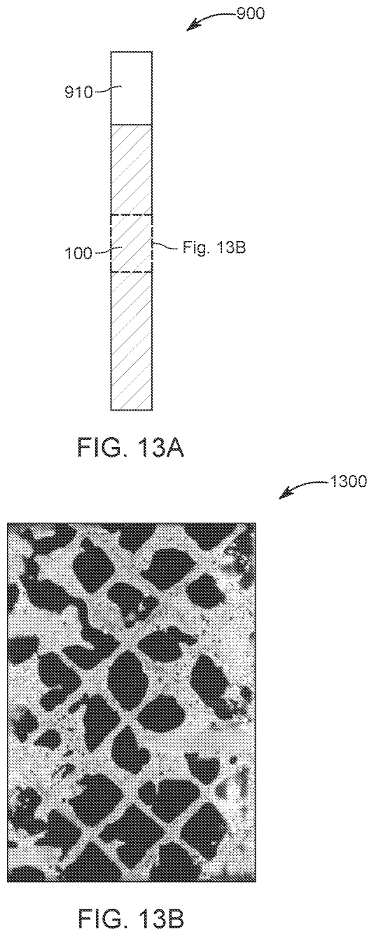

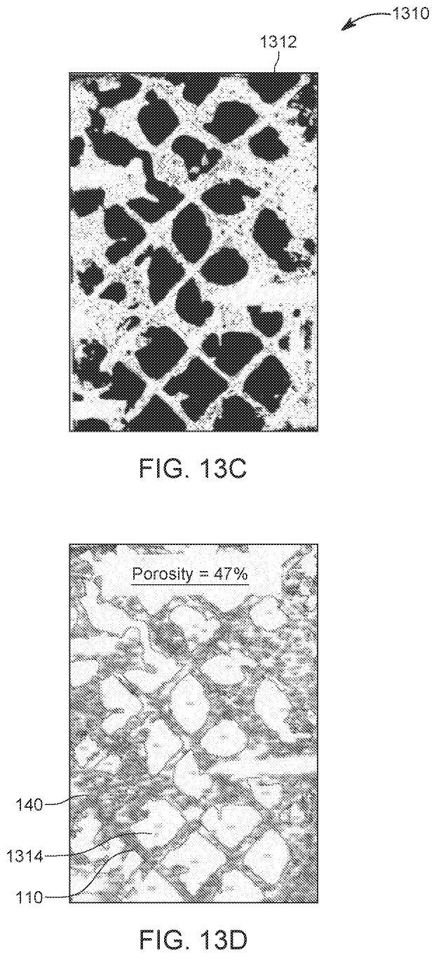

The bondline porosity was measured based on the two-dimensional micro-CT images that have been processed using the imageJ. The steps for the porosity measurement are shown in FIGS. 13A to 13D. Note that the porosity is defined herein as the ratio between (1) the amount of epoxy that is actually found in a cross-section area of the bondline, between the two CFRP composite panels 130 and 132 of the joint 200, when the corrugated structure 100 is present between the panels, and (2) the maximum possible amount of epoxy that can be placed in the cross-section area of the bondline between the two CFRP composite panels 130 and 132 in the joint 200, when the corrugated structure 100 is present.

FIG. 13A schematically illustrates the film 910 and the corrugated structure 100 that is placed between the two CFRP composite panels 130 and 132 in FIG. 9. A micro-CT image (original) 1300 of the specimen 900 is obtained from the central portion of the DCB specimen (for example, specimen with λ=20 mm and non-saturated adhesive). Then, this original image 1300 is binarized using the imageJ in order to transform the original micro-CT image into a monochromatic image 1310. Then, the black regions 1312 in the monochromatic image 1300, having an area size larger than 0.00001 mm² are automatically measured, and normalized relative to the total window area to obtain the porosity P (in percentage). FIG. 13D shows that the porosity P of the DCB specimen 900 is about 47%, displaying a high level of porosity 1314. Note that visible in FIG. 13D are the epoxy adhesive 140 and the mesh carrier 110.

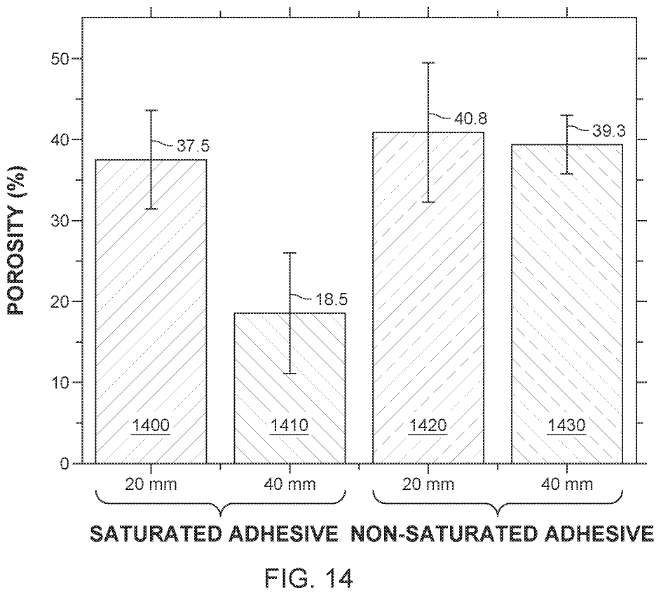

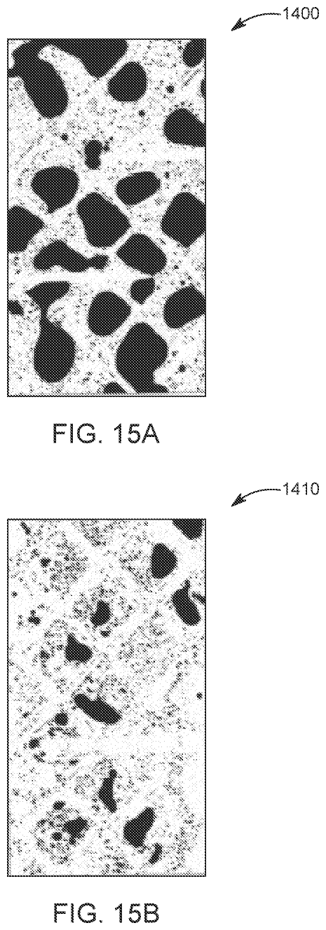

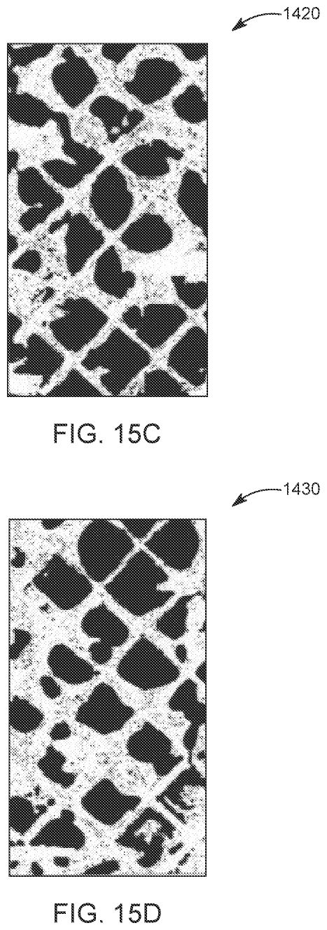

Results of the porosity measurement for the specimens investigated by the inventors are depicted in FIG. 14, and these results show that specimens 1420 and 1430 with the non-saturated adhesive exhibit around 40% porosity, which is relatively higher than that of the specimens 1400 and 1410 that have the saturated adhesive. The porosity for these specimens is illustrated in FIGS. 15A to 15D. The relatively high porosity is useful in triggering the strand formation that bridges the crack, and eventually improves the fracture toughness. In this regard, the inventors have observed that the traditional joints between two composite panels exhibit a porosity of less than 10%. This low porosity is due to the absence of the mesh carrier 110 and the weft net 120. Further, this low porosity in the traditional joints is due to the belief in the art that the lower the porosity, the better the strength of the joint. However, the inventors have found that the opposite is true, that a larger porosity is better for the strength of the joint than a low porosity. Thus, by controlling the porosity of the epoxy 140 between the composite joints to be larger than 10%, or larger than 20%, or between 35 and 45%, the unexpected result of the increase in the strength of the joint 200 is obtained.

The load tests performed with regard to FIGS. 8A and 8B indicated that the peak load (and subsequent load bearing capability) of the CFRP specimens with the corrugated structure 100 is significantly higher than that without the corrugated structure (control specimen). The average peak load of the control specimen was found to be 60-70 N, while that of specimens with the corrugated structures was around 120 N. Thus, the corrugated structure 100 could improve the peak load by more than double. However, the peak load is not so sensitive to the amount of adhesive. The experiments performed with regard to FIGS. 8A and 8B also shows that the specimens with saturated and non-saturated adhesive exhibit similar peak loads, suggesting that the initial fracture toughness (GIC initiation) would be similar regardless of the adhesive amount. However, it was found that the specimens with the saturated adhesive typically failed earlier than those with non-saturated adhesive, indicating that the former would have lower GIC propagation than the latter.

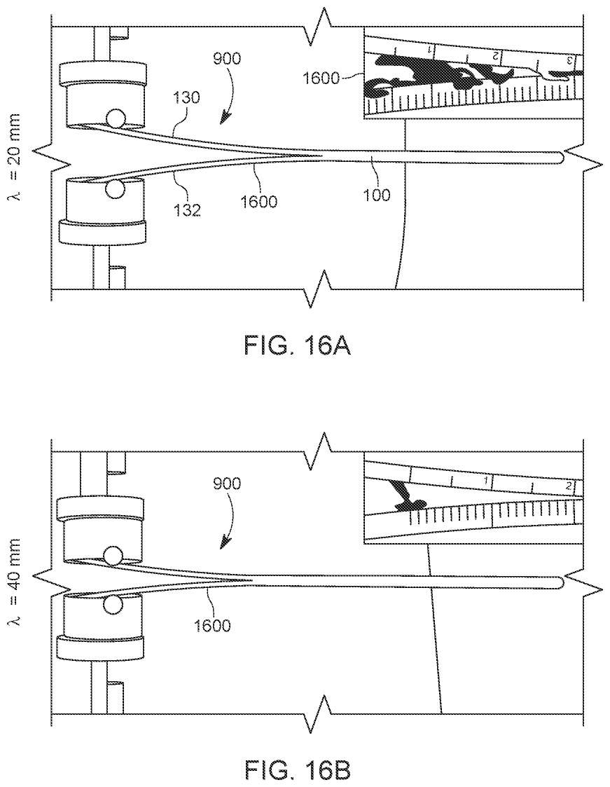

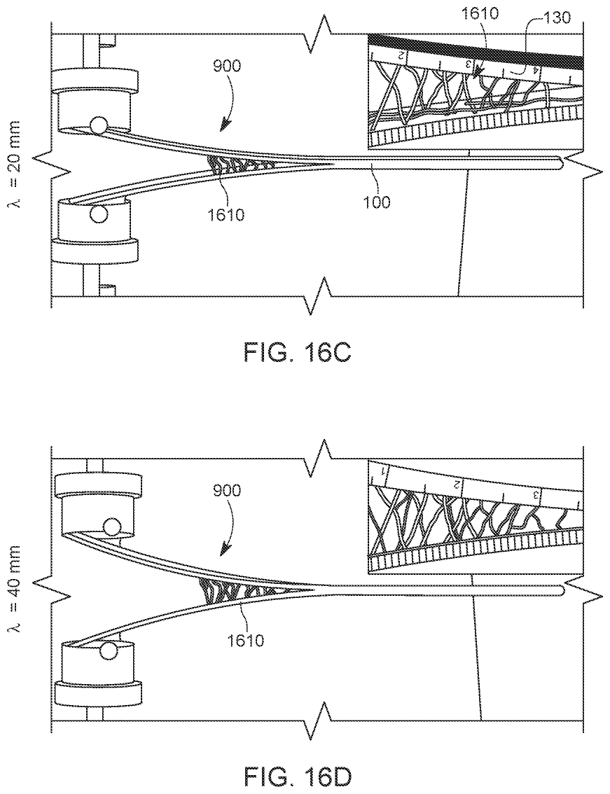

The fracture toughness enhancement discussed with regard to FIGS. 14 to 15D originates from the extrinsic toughening, which is an effective crack-stopping, which essentially is using a bridging by strands created by the corrugated structure 100. The number of strands 1600 in the specimens with the saturated adhesive (see FIGS. 16A and 16B) is minimum because the corrugated structure 100 is mostly confined or embedded within the thermoset phase (adhesive bondline). In such a configuration, the strands are difficult to form. Even if the strands could be formed, the strands are relatively short in length. Under large crack opening, the stretching of such a short strand was found to be minimal, which means that these strands immediately break together with the epoxy phase. Therefore, the toughness enhancement in specimens with saturated adhesive is rather limited.

In contrast, FIGS. 16C and 16D shows that the specimens with non-saturated adhesive 140 exhibit a large number of bridging strands 1610. The good anchoring of the strands 1610 on each side of the panels 130 and 132 is promoted by the initial wavy structure of the corrugated structure 100 and by the good bonding between the nylon net 110 and the epoxy 140 (see FIGS. 1 and 9B). Moreover, the thermoplastic strands 1610 are mainly embedded in a porous structure that gives enough freedom for the strands to deform and elongate. The ductility of the nylon, which is 6 times higher than the epoxy, contributes to the extrinsic toughening of the composite joint 200 by the stretching mechanism.

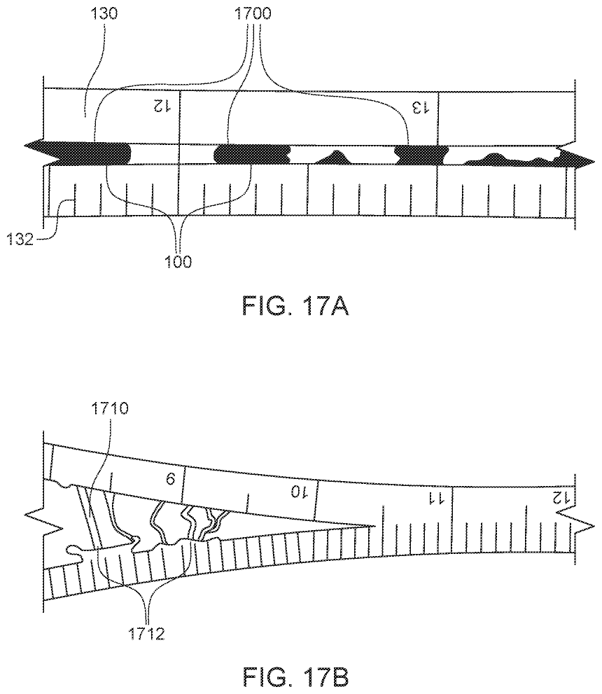

A more detailed mechanism responsible for the extrinsic toughening due to the corrugated structure 100 in the bonded joint 200 with non-saturated adhesive is now discussed. As shown in FIG. 17A, the existence of pores 1700, which are free of both the adhesive 140 and the corrugated structure 100, e.g., they are filled with air, at the initial stage of joining the composite panels 130 and 132, provides some room for the nylon mesh carrier 110 to create anchors and strands. Subsequently, when the two composite panels 130 and 132 are pulled apart, the strands 1710 are gradually stretched while the loading is increasing, while the anchors 1712 provide a strong attachment to the adherends 130 and 132, as shown in FIG. 17B. The waviness of the corrugated structure 100 intentionally helps in creating more strands 1710 between the two adherends. The micro-CT analysis performed on the non-failed samples shows that the anchoring typically occurs in the vicinity of the pores 1700.

The ductile nature of the nylon insert, the porosity of the corrugated structure, its waviness, and the epoxy-nylon interaction are conducive to a synergic interplay for creating crack arrest features that significantly improves secondary bonded CFRP composite panels. Thus, the proposed novel adhesive bondline architecturing achieves an improved strength by designing and embedding the 3D-printed corrugated structure 100 between the CFRP adherends 130 and 130. Based on the experiments discussed above, it was shown that the nylon insert, due to its shape and the associated porosity, could improve the fracture toughness of the joint by more than 4 times. The non-saturated adhesive (less amount of adhesive) could provide room for the strands to operate, which is responsible for fracture toughness enhancement. This suggests that a more ductile insert would provide further enhancement of the fracture toughness by creation of a tough crack arrest feature. The approach discussed above is also tailorable and easy-to-implement in large scale environments. The selected manufacturing method for the insert represents a more general technique; other techniques can certainly be adopted, e.g., static press using mold, injection molding.

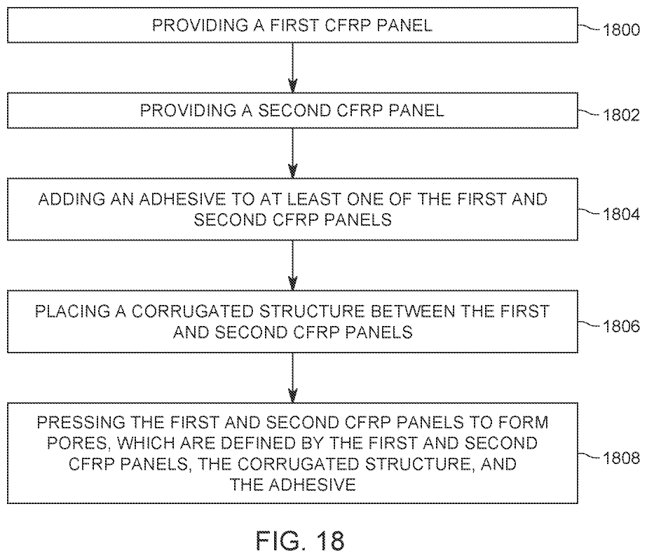

A method for forming the bonded composite joint 200 is now discussed with regard to FIG. 18. The method includes a step 1800 of providing a first CFRP panel 130, a step 1802 of providing a second CFRP panel 132, a step 1804 of adding an adhesive 140 to at least one of the first and second CFRP panels 130, 132, a step 1806 of placing a corrugated structure 100 between the first and second CFRP panels 130, 132, and a step 1808 of pressing the first and second CFRP panels 130, 132 to form pores 1700, which are defined by the first and second CFRP panels 130, 132, the corrugated structure 100, and the adhesive 140. The corrugated structure 100 has a shape defined by a given wavelength λ.

The method may further include a step of selecting the wavelength A of the corrugated structure to be less than 100 mm, and a step of controlling an amount of adhesive so that the pores between the first and second CFRP panels represent at least 10% of a volume between the first and second CFRP panels, as the corrugated structure is present.

The disclosed embodiments provide a corrugated structure that can be inserted between two composites panels for increasing a bonding between the two composite panels. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] R. Tao, Xi. Li, A. Yudhanto, M. Alfano, and G. Lubineau. On controlling interfacial heterogeneity to trigger bridging in secondary bonded composite joints: An efficient strategy to introduce crack-arrest features. Composites Science and Technology, 188:107964, 2020.

[2] K. Maloney and N. Fleck. Toughening strategies in adhesive joints. International Journal of Solids and Structures, 158:66-75, 2019.

[3] S. Heide-Jorgensen, S. T. De Freitas, and M. K. Budzik. On the fracture behaviour of CFRP bonded joints under mode I loading: Effect of supporting carrier and interface contamination. Composites Science and Technology, 160:97-110, 2018.

[4] R. Garcia and P. Prabhakar. Bond interface design for single lap joints using polymeric additive manufacturing. Composite Structures, 176:547-555, 2017.

[5] E. Dugbenoo, M. F. Arif, B. L. Wardle, and S. Kumar. Enhanced Bonding via Additive Manufacturing-Enabled Surface Tailoring of 3D Printed Continuous-Fiber Composites. Advanced Engineering Materials, 20(12):1-9, 2018.

[6] V. Damodaran, A. G. Castellanos, M. Milostan, and P. Prabhakar. Improving the Mode-II interlaminar fracture toughness of polymeric matrix composites through additive manufacturing. Materials and Design, 157:60-73, 2018.

1. A bonded composite joint comprising:
a first carbon fiber-reinforced polymer (CFRP) panel;
a second CFRP panel;
a corrugated structure placed between the first and second CFRP panels; and
an adhesive placed between the first and second CFRP panels and in contact with the corrugated structure,
wherein the corrugated structure has a shape defined by a given wavelength λ.

2. The joint of claim 1, wherein the wavelength λ of the corrugated structure is selected to be less than 100 mm.

3. The joint of claim 1, wherein the corrugated structure comprises:
a mesh carrier made of nylon, and
a weft net made of nylon,
wherein the weft net bends the mesh carrier to achieve the given wavelength λ.

4. The joint of claim 3, wherein the mesh carrier is a single network of nylon and the weft net includes plural parallel cords disposed along the mesh carrier so that one cord is under the mesh carrier and an adjacent cord is above the mesh carrier.

5. The joint of claim 3, wherein the mesh carrier and the weft net are made as a single structure.

6. The joint of claim 1, wherein the adhesive and the corrugated structure define pores between the first and second CFRP panels, and the pores are filled with air.

7. The joint of claim 6, wherein the pores represent at least 10% of a volume between the first and second CFRP panels, as the corrugated structure is present.

8. The joint of claim 6, wherein the pores represent at least 20% of a volume between the first and second CFRP panels, as the corrugated structure is present.

9. The joint of claim 6, wherein the pores represent at least 40% of a volume between the first and second CFRP panels, as the corrugated structure is present.

10. A corrugated structure configured to be placed between first and second composite panels for forming a joint, the corrugated structure comprising:
a mesh carrier made of nylon, and
a weft net made of nylon,
wherein the weft net shapes the mesh carrier to achieve a shape having a given wavelength λ.

11. The corrugated structure of claim 10, wherein the shape is a sinusoid.

12. The corrugated structure of claim 10, wherein the wavelength λ is less than 100 mm.

13. The corrugated structure of claim 10, wherein the wavelength λ is between 20 and 40 mm.

14. The corrugated structure of claim 10, wherein the mesh carrier is a single network of nylon and the weft net includes plural parallel cords disposed along the mesh carrier so that one cord is under the mesh carrier and an adjacent cord is above the mesh carrier.

15. The corrugated structure of claim 14, wherein each cord of the weft net is placed at a valley or a peak of the shape of the mesh carrier.

16. The corrugated structure of claim 14, wherein the mesh carrier and the weft net are made as an integral structure.

17. The corrugated structure of claim 10, further comprising:
an adhesive attached to the mesh carrier.

18. A method for forming a bonded composite joint, the method comprising:
providing a first carbon fiber-reinforced polymer (CFRP) panel;
providing a second CFRP panel;
adding an adhesive to at least one of the first and second CFRP panels;
placing a corrugated structure between the first and second CFRP panels; and
pressing the first and second CFRP panels to form pores, which are defined by the first and second CFRP panels, the corrugated structure, and the adhesive,
wherein the corrugated structure has a shape defined by a given wavelength λ.

19. The method of claim 18, further comprising:
selecting the wavelength λ of the corrugated structure to be less than 100 mm.

20. The method of claim 19, further comprising:
controlling an amount of the adhesive so that the pores between the first and second CFRP panels represent at least 10% of a volume between the first and second CFRP panels, as the corrugated structure is present.
